(19) United States
(12) Patent Application Publication
(10) Pub. No.: US 2018/0345547 A1
(43) Pub. Date: Dec. 6, 2018

(54) Method for Manufacturing a Plastic Product Such as a Flower Bucket

(71) Applicant: Naber Beheer B.V., Waalwijk (NL)

(72) Inventors: Wilhelmus Cornelis Maria Naber, Waalwijk (NL); Mike Antoon Jozef Naber, Waalwijk (NL)

(73) Assignee: Naber Beheer B.V., Waalwijk (NL)

(21) Appl. No.: 15/576,180

(22) PCT Filed: May 25, 2016
(86) PCT No.: PCT/NL2016/050370

§ 371 Date: Nov. 21, 2017

(30) Foreign Application Priority Data
May 28, 2015 (NL) 2014880

(51) Int. Cl. B29C 45/00; B29C 45/26; B29C 45/16; A01G 9/02

(52) U.S. Cl. CPC B29C 45/0046; B29C 45/26; B29L 2031/7136; A01G 9/021; B29C 45/16

(57) ABSTRACT

A method of manufacturing a plastic product (1) having a bottom and an upright wall extending from a periphery of the bottom in an injection mold having a bottom-forming cavity and a wall-forming cavity. The cavities of the injection mold are filled with fluid plastic while pressure is being exerted in two stages with an interruption of the supply of fluid plastic therebetween.

The invention relates to a method for manufacturing, through an injection molding process, a plastic product having a bottom and an upright wall extending from the periphery of the bottom, wherein an injection mold having an internal space for forming the product is applied, in particular an internal space comprising a bottom forming cavity for forming the bottom of the product and a wall forming cavity connecting to the periphery thereof for forming the upright wall of the product, and wherein the internal space of the injection mold is filled with fluid plastic while pressure is being exerted.

The invention also relates to a device that is destined to be applied for the purpose of manufacturing, through an injection molding process, a plastic product having a bottom and an upright wall extending from the periphery of the bottom, comprising: an injection mold having an internal space for forming the product, in particular an internal space comprising a bottom forming cavity for forming the bottom of the product and a wall forming cavity connecting to the periphery thereof for forming the upright wall of the product; at least three closeable injection elements for supplying fluid plastic at different positions in the internal space of the injection mold while pressure is being exerted; and a controller for operating the injection elements.

Plastic products having a bottom and an upright wall extending from the periphery of the bottom are commonly known. For example, such products can be applied as buckets or vases. In many cases, the bottom of such products has the shape of a planar disc having a circular periphery, and the upright wall of such products has the shape of a hollow cylinder having a circular inner and outer periphery, which may be tapered in the direction of the bottom. However, other embodiments of the product are also possible, for example, an embodiment in which the bottom has a square periphery, and in which the inner and outer periphery of the upright wall are square, too.

In the following, the invention will be explained and described in the context of flower buckets, i.e. buckets that are destined to be filled with a quantity of water and cut flowers, joined together in bouquets, or not. That does not alter the fact that the invention is also applicable to plastic products that are destined for another use or another application.

Flower buckets that are manufactured from plastic through injection molding are formed in an injection mold having an internal space, wherein a shape of the internal space is exactly adapted to a desired shape of the flower bucket. Thus, two parts can be discerned in the internal space of the injection mold: one part that serves to form the bottom of the flower bucket, and one part that serves to form the upright wall of the flower bucket, wherein the parts are connected to each other in order to be able to realize an interconnected entirety of bottom and wall. For the sake of clarity, the part of the internal space of the injection mold that serves to form the bottom of the flower bucket will hereinafter be referred to as bottom forming cavity, while the part of the internal space of the injection mold that serves to form the upright wall of the flower bucket will be referred to as wall forming cavity.

A manufacturing process of a flower bucket in which fluid plastic is introduced in the internal space of the injection mold at one central position in the bottom forming cavity and at three positions in the wall forming cavity is known from NL 1031864. Thus, NL 1031864 discloses an application of one central bottom injection element debouching into the bottom forming cavity and three wall injection elements debouching into the wall forming cavity. In comparison with a manufacturing process in which fluid plastic is introduced only at one central position in the bottom forming cavity, it is thus achieved that a so-called flow path of the plastic in the injection mold, i.e. a maximum distance along which the plastic, starting from an injection position, needs to flow through the injection mold until the injection mold is completely filled, is shorter, as a result of which the wall thickness of the flower bucket can be smaller and/or the pressures during the injection molding process can be lower.

According to the prior art, during the manufacturing process of a flower bucket, fluid plastic is firstly introduced at one central position in the bottom forming cavity. With pressure being exerted, the plastic flows to the edge of the bottom forming cavity, and subsequently flows into the wall forming cavity, wherein the flow changes direction. When the flow front of the plastic has reached the level of the wall injection elements, the wall injection elements are activated to introduce fluid plastic in the wall forming cavity, while the supply of fluid plastic by the bottom injection element stops. The injection molding process stops when the internal space of the injection mold is completely filled with plastic. When the plastic has cooled down to such an extent that it is capable of retaining its shape, the injection mold is opened, and the flower bucket thus obtained is removed from the injection mold. For the sake of completeness, it is noted that flower buckets are usually formed in mass production, wherein in each applied injection mold the process of filling the internal space of the injection mold with fluid plastic and the process of removing the formed flower bucket are continually alternated.

Flower buckets are disposables, which need to be manufactured at a low cost price. Moreover, flower buckets are hardly loaded during transport and use. Therefore, it is interesting to use as less material as possible for the purpose of manufacturing flower buckets. Assuming that an outer periphery and a height of the flower buckets are kept more or less the same, a saving of material could be obtained by decreasing the wall thickness of the flower buckets. In view of the fact that the flower buckets are not notably loaded during their lifespan, it is not required to have an all too robust design of the flower buckets. However, decreasing the wall thickness is not a realistic option in the prior art, because there is a practical lower limit to the wall thickness as a result of the way in which flower buckets are manufactured.

In the field of injection molding, it is generally known that a decrease of the wall thickness of a product to be manufactured involves an increase of the pressure that is needed for ensuring that the complete internal space of an applied injection mold is filled with plastic, according to a progressive relation, i.e. a relation that is more than proportional. This effect is even stronger when only the wall thickness is decreased and the other dimensions of the product remain more or less the same, wherein the relation between the wall thickness and the flow path changes. In addition, the projected surface of the product determines in combination with the pressures in the injection mold a so-called locking force, i.e. a force that is needed to keep the injection mold closed during the injection molding process. In practice, a lower limit of the wall thickness of the flower buckets is therefore determined by a maximum allowable and/or achievable pressure during the injection molding process.

It is an objective of the invention to realize a decrease of the wall thickness of flower buckets or similar products, despite the above-mentioned production-technical factors. The set objective is achieved by filling the internal space of the injection mold with fluid plastic in two stages during the injection molding process, with an interruption of the supply of fluid plastic between, wherein in a first stage, fluid plastic is supplied to the internal space of the injection mold at the position of a central area of the bottom forming cavity, after which the supply of fluid plastic is temporarily stopped, until the initiation of a second stage in which fluid plastic is supplied to the internal space of the injection mold at the position of a peripheral area of the bottom forming cavity surrounding the central area of the bottom forming cavity, until the internal space of the injection mold is completely filled.

Furthermore, the set objective is achieved by providing a device having an injection mold, at least three injection elements and a controller, as mentioned earlier, wherein the device particularly comprises at least one central injection element debouching into a central area of the bottom forming cavity of the injection mold, and at least two peripheral injection elements debouching into a peripheral area of the bottom forming cavity surrounding the central area of the bottom forming cavity, and wherein the controller is configured to realize the injection molding process in two stages, with an interruption of the supply of fluid plastic between, wherein an opened condition of the central injection element is realized in a first stage, while the peripheral injection elements are kept in a closed condition, after which the supply of fluid plastic is temporarily stopped, the central injection element is put to a closed condition and the peripheral injection elements are put to an opened condition, and wherein the supply of fluid plastic is initiated again in a second stage in order to achieve complete filling of the internal space of the injection mold in that stage.

According to the invention, a central bottom part of the product is molded first, after which the supply of fluid plastic stops. In doing so, a pause is introduced in the injection molding process. During this pause, curing of the plastic of the bottom part takes place. Furthermore, this pause offers an opportunity to close the central injection element and to open the peripheral injection elements. Subsequently, a second injection of plastic takes place for forming a peripheral bottom part and a wall part connecting thereto of the product, wherein fluid plastic is introduced in the injection mold as long as necessary until complete filling of the internal space of the injection mold is achieved. For the sake of completeness, it is noted that the supply of plastic is stopped at that very moment. In the internal space of the injection mold, a combination of the relatively hard central bottom part and the still fluid plastic of the remaining part of the product to be manufactured is present by that time. As soon as the plastic of the remaining part has sufficiently cured, the product can be released from the injection mold.

According to the invention, the injection molding process of a flower bucket or a similar product is performed in two stages, with an interruption of the supply of fluid plastic between. As a consequence, significantly less locking force is needed, so that a design of the flower bucket having a wall thickness that is further reduced with respect to the prior art becomes a practical possibility. The fact is that the invention provides the possibility to mold a central bottom part of the flower bucket in a first stage and to let this cure sufficiently prior to molding a peripheral bottom part and a wall part connecting thereto in a second stage, wherein, in the second stage, the projected surface of the central bottom part has no influence on the locking force. Preferably, the interruption of the supply of fluid plastic between the two stages lasts as long as is necessary to let the plastic that has been supplied to the central area of the bottom forming cavity in the first stage cure, i.e. allow it to harden to a sufficient extent so that there is no need for exerting external pressure in order to prevent deformation thereof.

The invention offers more possibilities than decreasing the wall thickness of flower buckets. For instance, it is also possible to realize a reduction of the pressures in the injection mold and the necessary locking force when the wall thickness is not decreased, or at least is not decreased to a maximum extent. In such a case, less heavy injection molding machines can be applied, whole the injection molding process consumes less energy.

Within the framework of the invention, it is a practical option to supply fluid plastic to the internal space of the injection mold at one central position in the bottom forming cavity in the first stage. Furthermore, it is practical option to supply fluid plastic to the internal space of the injection mold at at least two positions near the periphery of the bottom forming cavity in the second stage. The number of positions may be six, for example. For the purpose of a proper realization of the injection molding process, it is advantageous when the positions at which the peripheral injection elements debouche into the bottom forming cavity are evenly distributed over the periphery of the bottom forming cavity.

For the purpose of many practical applications of the invention, it will be a fact that in the two stages, fluid plastic of the same type is supplied to the internal space of the injection mold. A consequence of this fact is that it is sufficient to apply one conduit system for the plastic. In general, injecting fluid plastic at more than one position in the injection mold can well be realized by applying a system of supply conduits having a closeable injection element at an end of each supply conduit. Such an injection element may comprise a needle valve, for example. Needle valves are well controllable, so that defined quantities of fluid plastic can be emitted in an accurate way. For the purpose of controlling the injection elements, any appropriate possibility can be used, including applying a micro controller that can be preprogrammed to realize the desired execution of the injection molding process with the two stages.

In order to promote the flowing process of the plastic in the wall forming cavity during the second stage of the injection molding process, it is possible to make use of so-called flow promotors. In such a case, the wall forming cavity comprises expanded areas that are configured to realize a larger wall thickness of the upright wall of the product than the remaining areas of the wall forming cavity, wherein positions of the expanded areas with respect to the periphery of the bottom forming cavity correspond to positions of the peripheral injection elements with respect to the periphery of the bottom forming cavity, so that the plastic emitted by the injection elements is allowed to flow directly into the expanded areas. The application of the expanded areas contributes to letting the pressures prevailing during the injection molding process be controllable, because, starting from the bottom forming cavity, the plastic may follow the path of the least resistance first, through the expanded areas, prior to being pressed into the intermediate areas. Preferably, the expanded areas of the wall forming cavity have a substantially rectangular shape and extend in the upright direction.

The wall forming cavity can be configured to, starting from a certain level with respect to the bottom forming cavity, realize a smaller wall thickness of the wall than until that level, with the exception of the expanded areas of the wall forming cavity. Usually, when the plastic product is intended to be used as flower bucket, it is not only used to contain flowers, but also a quantity of water. It has appeared that by performing an injection molding process in two stages in accordance with the invention, it is possible to have wall thicknesses that are so small that leakage may appear when the flower bucket is manufactured from recycled plastic. This is especially the case when the recycled plastic has components of diaper waste, which is transform from a solid state to a gel-like state upon exposure to water. In order to prevent this, despite the desire to have as less as possible plastic in the flower bucket, it is a realistic option to let a lowest part of the wall, i.e. a part of the wall connecting to the bottom, be thicker than a highest part of the wall, which is not intended to surround a quantity of water and therefore can be as thin as feasible when applying the injection molding process as proposed herewith. In general, according to the invention, in a design that is aimed at preventing problems associated with leakage, the wall of the plastic product having a bottom and an upright wall extending from the periphery of the bottom can have a wall thickness of substantially 0.5 mm, starting from a level of substantially 50 mm with respect to the bottom, and a wall thickness of substantially 0.55 mm up to said level.

According to an insight underlying the invention besides other insights, it is actually possible to obtain a good fixation of the plastic that is introduced in the internal space of the injection mold during the second stage to the cured plastic of the central bottom part formed during the first stage when the peripheral area of the bottom forming cavity is configured to realize a larger wall thickness of the bottom of the product than the central area of the bottom forming cavity. In particular, it is possible to achieve herewith that an edge part of the central bottom part can be embedded in the plastic of the peripheral bottom part when it is introduced in the injection mold.

It is advantageous when the wall forming cavity is configured to realize a corrugated shape of the wall, up from a certain level with respect to the bottom forming cavity, in particular a shape having a pattern of annular ribs along the periphery of the wall. On the basis thereof, a product is obtained of which the wall, up from a certain level with respect to the bottom, has a corrugated shape, in particular a shape having a pattern of annular ribs along the periphery of the wall. On the basis of the presence of the ribs, the product is locally enforced. As a consequence, buckling of the wall of the product when the product is taken hold of by one hand near an upper rim thereof can be prevented.

The invention will be explained in further detail on the basis of the following description of a flower bucket and a manufacturing process thereof. In the process, reference will be made to the drawing, in which equal reference signs indicate equal or similar parts, and in which:

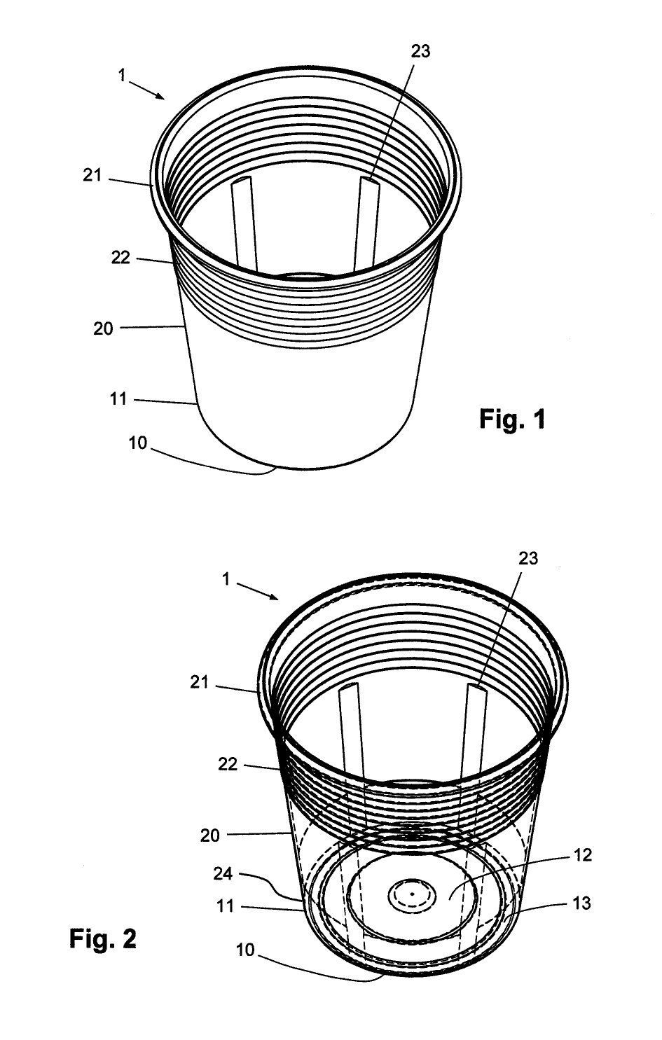

FIG. 1 shows a perspective view of the flower bucket;

FIG. 2 also shown a perspective view of the flower bucket, wherein an upright wall of the flower bucket is depicted as being transparent so that all aspects of the design of the flower bucket are visible;

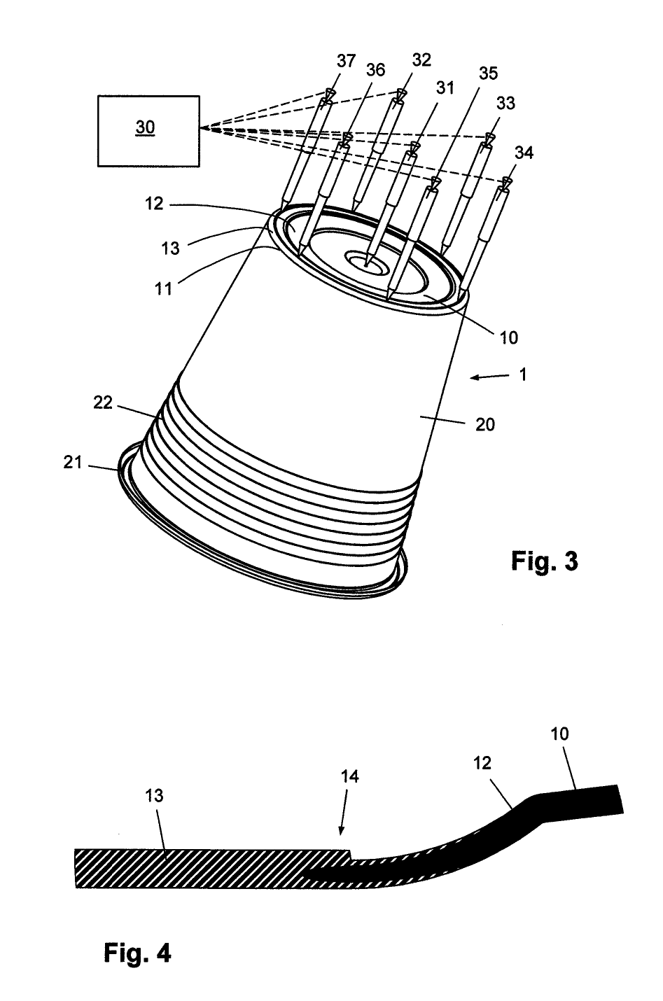

FIG. 3 illustrates the positioning of the injection elements with respect to the flower bucket during an injection molding process thereof and diagrammatically shows a controller of the injection elements;

FIG. 4 illustrates a connection of a peripheral bottom part to a central bottom part of the flower bucket; and

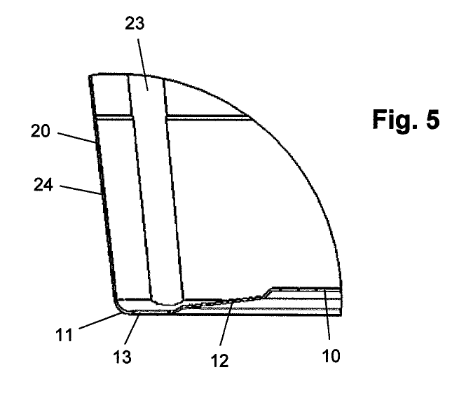

FIG. 5 shows in detail a part of a bottom and a part of the wall of the flower bucket connecting thereto, in sectional view.

Indications such as “below” and “above” as used in the following description are based on the assumption of a normal orientation of the flower bucket, wherein the bottom of the flower bucket is located below, and wherein an open side of the flower bucket is located above, and should not at all be understood so as to be limiting to the scope of the invention.

FIGS. 1 and 2 show a flower bucket 1 as an example of a plastic product according to the invention. In general, the flower bucket 1 has a bottom 10 and an upright wall 20 extending from the periphery 11 of the bottom 10. In the shown example, the periphery 11 of the bottom 10 has a substantially circular shape, and the upright wall 20 is formed as a hollow cylinder that is tapered in the direction of the bottom 10, and that has a substantially circular inner and outer periphery. The wall 20 is at the bottom side thereof connected to the periphery 11 of the bottom 10, while the wall 20 is provided with an annular top rim 21 at the top side thereof. This rim 21 serves for enforcement of the flower bucket 1, and additionally offers a user of the flower bucket 1 a convenient possibility of picking up and holding the flower bucket 1. An upper part of the wall 20 is provided with a pattern of annular ribs 22, as a result of which this part of the wall 20 is enforced and buckling of the wall 20 upon picking up the flower bucket 1 with one hand is prevented.

In the normal orientation of the flower bucket 1 as shown in FIGS. 1 and 2, with the bottom 10 at the bottom side, the flower bucket 1 can be filled with a quantity of water, and flowers can be put in place in the flower bucket 1. Due to the tapered shape of the upright wall 20, the flower bucket 1 is capable of receiving an identical flower bucket 1 for a large part thereof, whereby the flower bucket 1 is well stackable. This is advantageous in view of transport and storage of the flower bucket 1.

The flower bucket 1 is manufactured from plastic through injection molding. In the injection molding process, use is made of an injection mold (not shown) having an internal space, wherein a shape of the internal space is exactly adapted to the shape of the flower bucket 1. In that case, the flower bucket 1 is obtained by filling the internal space of the injection mold with fluid plastic and allowing it to cool down. The injection mold is divided in at least two parts, which are tightly pressed together under the influence of a locking force during the injection molding process. After a flower bucket 1 has been formed in the injection mold, the parts of the injection mold are moved apart, and the flower bucket 1 can be removed from the injection mold. Injection molding is a process that is known per se, wherein the injection mold is put in place in an injection molding machine, which, besides other components, is provided with means to keep the injection mold closed during injection molding by exerting forces on the parts of the injection mold that are sufficient for counteracting the pressures prevailing during injection molding, and means for supplying fluid plastic to the internal space of the injection mold. Aspects like the division of the injection mold in parts, wherein the fact that the flower bucket 1 needs to be removable therefrom after the injection molding process is taken into account, and the general design of the injection molding machine can be realized by a person skilled in the art of injection molding without needing further information. Only insofar as such aspects are important in the context of the invention, a further explanation thereof will be given in the following.

During the injection molding process of the flower bucket 1, fluid plastic is injected into the injection mold at various positions. In FIG. 3, a possible arrangement of injection elements 31, 32, 33, 34, 35, 36, 37 of an injection molding machine is shown, wherein also a flower bucket 1 to be formed is shown. In view of the fact that the shape of the flower bucket 1 equals the shape of the internal space of the injection mold that is applied during the injection molding process, it is possible for FIG. 3 to be taken as an illustration of the arrangement of the injection elements 31, 32, 33, 34, 35, 36, 37 with respect to this space.

In the following, the internal space of the injection mold will be referred to as forming cavity, a part of the internal space of the injection mold that is configured to form the bottom 10 of the flower bucket 1 will be referred to as bottom forming cavity, and a part of the internal space of the injection mold that is configured to form the upright wall 20 of the flower bucket 1 will be referred to as wall forming cavity.

In the arrangement as shown in FIG. 3, one injection element 31 is present that serves for injecting fluid plastic in a central area of the bottom forming cavity, and six injection elements 32, 33, 34, 35, 36, 37 are present that serve for injecting fluid plastic in a peripheral area of the bottom forming cavity surrounding the central area of the bottom forming cavity. For the sake of clarity, the first injection element 31 will be referred to as central injection element 31, while the latter injection elements 32, 33, 34, 35, 36, 37 will be referred to as peripheral injection elements 32, 33, 34, 35, 36, 37. In the shown example, the central injection element 31 has a central position with respect to the bottom 10 of the flower bucket 1 to be formed, and the peripheral injection elements 32, 33, 34, 35, 36, 37 are evenly distributed with respect to the periphery 11 of the bottom 10 of the flower bucket 1 to be formed. In analogy thereto, it is a fact that in an injection molding machine for forming the shown flower bucket 1, the central injection element 31 debouches into the bottom forming cavity at a central position, and that the peripheral injection elements 32, 33, 34, 35, 36, 37 are distributed evenly over a periphery of the bottom forming cavity.

In FIG. 3, a controller 30 of the injection elements 31, 32, 33, 34, 35, 36, 37 is diagrammatically shown in the form of a block, wherein couplings between the injection elements 31, 32, 33, 34, 35, 36, 37 and the controller 30 are indicated by means of dashed lines. According to the invention, the controller 30 is programmed in a special way for controlling the injection elements 31, 32, 33, 34, 35, 36, 37 during the injection molding process of the flower bucket 1, as will become apparent from the following description. The controller 30 and the couplings thereof to the injection elements 31, 32, 33, 34, 35, 36, 37 can be designed in any suitable manner. For example, the controller 30 may comprise a micro controller. The injection elements 31, 32, 33, 34, 35, 36, 37 are closeable and may comprise needle valves, for example.

The flower bucket 1 is formed on the basis of an injection molding process, in particular an injection molding process that is performed in two stages, having an interruption of the supply of fluid plastic between. In particular, a central bottom part 12 is formed during a first stage. To that end, the central injection element 31 is put to an opened condition by the controller 30, while the peripheral injection elements 32, 33, 34, 35, 36, 37 are kept in a closed condition. A first quantity of plastic is introduced at a central position in the bottom forming cavity through the central injection element 31. The plastic flows out from the central position in the direction of the bottom forming cavity, so that the central bottom part 12 is realized in the form of a disc having a substantially circular periphery. The quantity of plastic is less than would be needed to reach the periphery of the bottom forming cavity. Thus, a peripheral area of the bottom forming cavity remains free of plastic in the first stage. In particular, the plastic flows out approximately to such an extent that the periphery of the central bottom part 12 more or less corresponds to an imaginary circle that is defined by the peripheral injection elements 32, 33, 34, 35, 36, 37. The pressures prevailing in the injection mold during the first stage are only related to the introduction of the plastic for the central bottom part 12.

As soon as the quantity of plastic that is intended for forming the central bottom part 12 has been supplied to the bottom forming cavity, the supply of plastic to the forming cavity of the injection mold is stopped. The central injection element 31 is put from the opened condition to the closed condition by the controller 30. Meanwhile, the plastic of the central bottom part 12 is provided with an opportunity to cure.

Preferably, the second stage of the injection molding process does not start earlier than when the bottom part 12 is sufficiently shape-retaining, such that it can do without external pressure for retaining the shape thereof. For the purpose of starting the second stage, the controller 30 puts the peripheral injection elements 32, 33, 34, 35, 36, 37 in the opened condition, while the central injection element 31 is kept in the closed condition. Thus, in the second stage, the fluid plastic is supplied to the forming cavity of the injection mold only by the peripheral injection elements 32, 33, 34, 35, 36, 37, particularly at the position of a peripheral area of the bottom forming cavity. The supply of fluid plastic continues until the forming cavity of the injection mold is completely filled and the complete flower bucket 1 is formed therewith. In the second stage, a peripheral bottom part 13 surrounding the central bottom part 12 is formed, and the wall 20 is also formed on the basis of plastic that is pressed from the bottom forming cavity to the wall forming cavity, in a direction away from the bottom forming cavity, all the way to the part of the wall forming cavity that is configured to form the top rim 21 of the flower bucket 1. The pressures prevailing in the injection mold during the second stage are only related to the introduction of the plastic for the peripheral bottom part 13 and the wall 20, while the projected surface of the central bottom part 12 has no influence on those pressures, in view of the fact that this bottom part 12 has cured. By letting the supply of plastic take place in two stages, wherein the plastic that is supplied in the first stage is allowed curing time before the second stage is started, it is achieved that the pressures remain controllable, i.e. within conventional limits, throughout the entire injection molding process, despite relatively small wall thicknesses of the different areas of the flower bucket 1. It is practical to use one and the same type of plastic for the entire flower bucket 1.

At the end of the second stage, the forming cavity of the injection mold is completely filled with plastic, partly with already cured plastic and partly with plastic that still needs to cure. When all of the plastic has cooled down to such an extent that it is capable of retaining its shape, the parts of the injection mold are moved apart, and the flower bucket 1 is removed from the injection mold.

The wall thickness of the wall 20 can be chosen to be so thin, for example, 0.5 mm at a height in an order of 250 to 300 mm, that locally expanded areas of the wall forming cavity of the wall forming cavity are required for keeping the pressures during the second stage of the injection molding process controllable. As a consequence, thickened areas 23 are obtained in the wall 20 of the flower bucket. In the shown example, the expanded areas of the wall forming cavity extend along the entire height of the wall forming cavity, wherein these areas have an elongated shape and extend at positions with respect to the periphery of the bottom forming cavity that correspond to positions of the peripheral injection elements 32, 33, 34, 35, 36, 37 with respect to the periphery of the bottom forming cavity. Thus, in the shown example, six expanded areas are present in the wall forming cavity, so that the wall 20 of the flower bucket 1 is provided with six thickened areas 23. In the shown example, these thickened areas 23 are located at the inside of the wall 20, which provides an advantageous esthetical effect.

FIG. 4 illustrates how a firm and watertight connection can be realized at the position where the peripheral bottom part 13 of the second stage of the injection molding process connects to the central bottom part 12 of the first stage of the injection molding process. In particular, the wall thickness of the peripheral bottom part 13 is chosen so as to be larger than the wall thickness of the central bottom part 12, so that a ring-shaped peripheral rim of the central bottom part 12 can be embedded in the plastic of the peripheral bottom part 13. For example, the wall thickness of the central bottom part 12 can be 0.55 mm, while the wall thickness of the peripheral bottom part 13 may then be 0.75 mm, for example. At the position of the transition of the central area to the peripheral area of the bottom forming cavity of the injection mold, the plastic of the first stage flows out to some extent in the direction of the peripheral area, and the plastic of the second stage flows out to some extent in the direction of the central area, so that an overlap area 14 is obtained in the bottom 10 of the flower bucket 1, in which the plastic of the second stage has flowed above and below the plastic of the first stage. By positioning the overlap area 14 near to the connection of the wall 20 to the periphery 11 of the bottom 10, deformation of the flower bucket 1 on the basis of internal tensions is prevented, because the flower bucket 1 is relatively strong at that position. For the sake of completeness, it is noted that in FIG. 4, the plastic of the first stage is depicted as being completely black, and that the plastic of the second stage is depicted in a hatched fashion. It is also noted that flowed out edge portions of the central bottom part 12 and the peripheral bottom part 13, which are present in the overlap area 14, are depicted only diagrammatically in FIG. 4. In reality, it may be expected that these edge portions have a less regular shape than shown, which is beneficial to the interconnection thereof.

FIG. 5 serves for illustrating the possibility that in the areas outside of the thickened areas 23, the wall 20 of the flower bucket 1 is formed with a somewhat thickened lowest part 24. As a consequence thereof, watertightness of the flower bucket 1 is guaranteed at the very position where the presence of water can actually be expected during use of the flower bucket 1. For example, the thickened lowest part 24 of the wall 20 can have a wall thickness of 0.55 mm, while the remaining part of the wall 20 can have a wall thickness of only 0.5 mm. The height of the thickened lowest part 24 of the wall 20 can be 50 mm, for example.

It will be clear to a person skilled in the art that the scope of the invention is not limited to the examples discussed in the foregoing, but that various variations and modifications thereof are possible without deviating from the scope of the invention as defined in the attached claims. On the one hand, these claims relate to a method for manufacturing, through an injection molding process, a plastic product having a bottom and an upright wall extending from the periphery of the bottom, and, on the other hand, to a device that is destined to be applied for the purpose of manufacturing, through an injection molding process, a plastic product having a bottom and an upright wall extending from the periphery of the bottom.

The shown flower bucket 1 is only one example of the many possible plastic products having a bottom and an upright wall extending from the periphery of the bottom, which can be formed by applying the method according to the invention. For achieving optimal results, details such as the number of injection elements 31, 32, 33, 34, 35, 36, 37 can be adapted as desired to any possible practical realization of the invention. Aspects like applying expanded areas in the wall forming cavity of the injection mold, a division of the areas of the wall forming cavity outside of the expanded areas in a more expanded part and a less expanded part, wherein the more expanded part is located at the connection of the wall forming cavity to the bottom forming cavity, and arranging corrugations in the wall are not essential within the framework of the invention, and are not essential within the framework of the example as described either.

A possible summary of the invention is as follows. For the purpose of manufacturing a plastic product 1 having a bottom 10 and an upright wall 20 extending from the periphery 11 of the bottom 10, an injection mold having a bottom forming cavity and a wall forming cavity connecting to the periphery thereof is applied. The forming cavity of the injection mold is filled with fluid plastic while pressure is being exerted, in two stages with an interruption of the supply of fluid plastic between, wherein only a central bottom part 12 is formed in a first stage, after which the supply of plastic is temporarily stopped, until the start of a second stage in which the forming cavity of the injection mold is further filled.

1. A method for manufacturing a plastic product comprising:
injecting, in a first stage, fluid plastic into an internal space of an injection mold;
terminating the first stage of injection, wherein the supply of fluid plastic to the injection mold is stopped for a duration of time; and
injecting, in a second stage, fluid plastic into the internal space of the injection mold until the internal space of the injection mold is completely filled;
wherein the internal space of the injection mold comprises a bottom-forming cavity for forming a bottom of the plastic product and a wall-forming cavity connecting to a periphery area of the bottom-forming cavity for forming an upright wall of the product;
wherein during the first stage injection, fluid plastic is supplied to a central area of the bottom-forming cavity; and
wherein during the second stage injection, fluid plastic is supplied to the periphery area of the bottom-forming cavity surrounding the central area of the bottom-forming cavity.

2. The method according to claim 1, wherein the duration of time lasts as long as is necessary to let the plastic supplied during the first stage injection to the central area of the bottom-forming cavity cure.

3. The method according to claim 1, wherein, in the first stage, fluid plastic is supplied to the internal space of the injection mold at one central position in the bottom-forming cavity.

4. The method according to claim 1, wherein, in the second stage, fluid plastic is supplied to the internal space of the injection mold at more than one position in proximity to the periphery of the bottom-forming cavity.

5. The method according to claim 4, wherein, in the second stage, fluid plastic is supplied to the internal space of the injection mold at six positions in proximity to the periphery of the bottom-forming cavity.

6. The method according to claim 1, wherein in the two stages, fluid plastic of the same type is supplied to the internal space of the injection mold.

7. A device for manufacturing a plastic product having a bottom and an upright wall extending from a periphery of the bottom, comprising:
an injection mold having an internal space for forming the product, wherein the internal space comprises a bottom-forming cavity for forming the bottom of the product, and a wall-forming cavity connecting to a periphery of the bottom-forming cavity for forming the upright wall of the product;
closeable injection elements for supplying fluid plastic at different positions of the internal space of the injection mold including a central injection element debouching into a central area of the bottom-forming cavity, and two peripheral injection elements debouching into the peripheral area of the bottom-forming cavity surrounding the central area of the bottom-forming cavity; and
a controller for operating the injection elements, wherein the controller is configured to an injection molding process comprising injecting, in a first stage, fluid plastic into the internal space of the injection mold, terminating the first stage of injection, wherein the supply of fluid plastic to the injection mold is stopped for a duration of time, and injecting, in a second stage, fluid plastic into the internal space of the injection mold until the internal space of the injection mold is completely filled, wherein an opened condition of the central injection element is realized in the first stage, while the peripheral injection elements are kept in a closed condition, after which the supply of fluid plastic is temporarily stopped for the duration of time, the central injection element is placed into a closed condition and the peripheral injection elements are placed into an opened condition, and wherein the supply of fluid plastic is initiated again in the second stage in order to achieve complete filling of the internal space of the injection mold.

8. The device according to claim 7, wherein the positions at which the peripheral injection elements debouche into the bottom-forming cavity are evenly distributed over the peripheral area of the bottom-forming cavity.

9. The device according to claim 7, wherein areas of the wall-forming cavity are expanded areas that are configured to realize a larger wall thickness of the upright wall of the product than the remaining areas of the wall-forming cavity; and
wherein positions of the expanded areas with respect to the periphery of the bottom-forming cavity correspond to positions of the peripheral injection elements with respect to the periphery of the bottom-forming cavity.

10. The device according to claim 9, wherein the expanded areas of the wall-forming cavity have a substantially elongated shape and extend in the upright direction.

11. The device according to claim 9, wherein the wall-forming cavity is configured to, starting from a certain level with respect to the bottom-forming cavity, realize a smaller wall thickness of the upright wall than until that level, with the exception of the expanded areas of the wall-forming cavity.

12. The device according to claim 7, wherein the peripheral area of the bottom-forming cavity is configured to realize a larger wall thickness of the bottom of the product than the central area of the bottom-forming cavity.

13. The device according to claim 7, wherein the wall-forming cavity is configured to realize a corrugated shape of the upright wall, up from a certain level with respect to the bottom-forming cavity.

14. A plastic product comprising:
a bottom; and
an upright wall extending from a periphery of the bottom.

15. The plastic product according to claim 14, wherein the upright wall has a corrugated shape, starting from a certain level with respect to the bottom.

16. The method according to claim 1, wherein the steps of injecting fluid plastic comprise injecting fluid plastic under pressure.

17. The device according to claim 7, wherein the wall-forming cavity is configured to realize a corrugated shape of the upright wall, up from a certain level with respect to the bottom-forming cavity, the corrugated shape having a pattern of annular ribs along the periphery of the upright wall.

18. The plastic product of claim 14, wherein the height of the upright wall is approximately 50 mm, and has a wall thickness of approximately 0.55 mm in proximity of the bottom and terminating in a wall thickness of approximately 0.5 at its height.

19. The plastic product according to claim 14, wherein the upright wall has a corrugated shape, starting from a certain level with respect to the bottom, the corrugated shape having a pattern of annular ribs along the periphery of the upright wall.
